(19) United States
(12) Patent Application Publication
(10) Pub. No.: US 2015/0089369 A1
(43) Pub. Date: Mar. 26, 2015

(54) METHOD FOR SCROLLING THROUGH DIGITAL CONTENT IN MOBILE TERMINAL AND MOBILE TERMINAL DEVICE FOR SAME

(71) Applicant: Jae Seok AHN, Seoul (KR)

(72) Inventor: Jae Seok Ahn, Arlington, VA (US)

(21) Appl. No.: 14/391,385

(22) PCT Filed: Apr. 9, 2013
(86) PCT No.: PCT/KR2013/002977

§ 371 Date: Oct. 8, 2014

(30) Foreign Application Priority Data
Apr. 10, 2012 (KR) 10-2012-0037106
May 30, 2012 (KR) 10-2012-0057710

(51) Int. Cl. G06F 3/0485; G06F 3/0484; G06F 3/0488

(52) U.S. Cl. CPC G06F 3/0485; G06F 3/04883; G06F 3/04842
USPC 715/716; 715/784

(57) ABSTRACT

The present invention relates to a scrolling method in a mobile terminal. When a user drags a touch point drawing a circular trajectory on a screen, a scroll direction and a scroll speed are determined based on the dragging direction and the size of the circular trajectory, respectively. Therefore, according to the present invention, precise and intuitive scrolling control is enabled even when a multimedia file having a long playback time or a list having a lot of items is processed in spite of the small screen size of the mobile terminal.

### FIELD

The present invention relates to a method and apparatus for scrolling digital content in a mobile terminal.

### RELATED ART

In accordance with the advancement in the specifications of a mobile terminal such as smart phone, tablet PC, etc., the limitations on the size and format of digital content that can be handled in the mobile terminal are disappearing step by step. While a threshold of the size of digital content than can be processed in the mobile terminal has been going up steadily, the size of display for a mobile terminal cannot increase boundlessly beyond a certain point because of the need for portability. Because of this limitation of display size, scrolling within a large size of digital content on a small display of the mobile terminal may not a simple job oftentimes, for example, in cases of searching a particular point on a timeline of a long video file, searching to a desired part in a large text file, or browsing a number of contacts entries. A linear single scroll bar, which is commonly used now for scrolling digital contents, is not an effective tool for a precise and intuitive control in these cases.

FIG. 1A and FIG. 1B are diagrams which illustrate a conventional method for scrolling digital content in a mobile terminal.

FIG. 1A shows the screen of the mobile terminal which is currently playing a video or music. As shown in FIG. 1A, the scroll bar 100 is displayed on the screen when multimedia content such as a video or music is being played and a user may search his desired point on the timeline by dragging the button 101 to the left or right on the scroll bar 100.

The length of the scroll bar 100 is subject to a certain limitation due to the limitation of display size for the mobile terminal, which makes it hard for the user to scroll precisely on the timeline of the video or music having a long running-time. Further, the scroll bar sometimes may not be allowed to take up the whole width of the screen size particularly when there is some additional information to be displayed on the screen such as current time or remaining time, as shown in FIG. 1A. Furthermore, it is very likely that the running-time of multimedia content for a mobile terminal is going to increase steadily in accordance with the advancement of the technologies in the mobile industry such as multimedia compression, memory manufacturing or communication techniques, but the restrictions on the length of the single linear scroll bar may not be lifted so far as there exists a need for portability of mobile terminal.

FIG. 1B shows a screen of the mobile terminal while multiple items are being scrolled. In this example, the items are assumed to be contacts entries. Ordinarily, the user touches the screen and then flicks the touch point 102 to the left and the right or to the up and down in order to browse through a number of contacts entries, or alternatively, a user may have to push the arrow 103 or drag the button on the scroll bar for scrolling. Therefore, with lots of the contacts entries, browsing all the items is likely to take more time and further the fine scrolling will be hard to achieve.

### Technical Problems

A method for effectively and deliberately scrolling over a long multimedia file or a list containing numerous items in a mobile terminal embedded with a restrictive size of display, via its touch screen.

### Solution to the Technical Problems

The present invention provides a method for determining a scroll speed and a scroll direction based on the size of a circular trajectory and a dragging direction respectively, when a user drags a touch point drawing the circular trajectory on a screen of a mobile terminal.

### Advantageous Effect

According to the present invention, precise and intuitive scrolling is enabled in spite of small screen size of the mobile terminal.

### DESCRIPTION OF THE DRAWINGS

FIGS. 1A and 1B are diagrams which illustrate a conventional method for scrolling digital content in a mobile terminal.

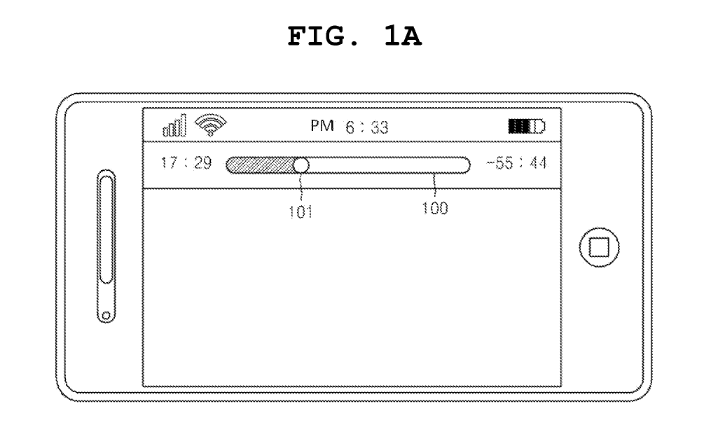

FIG. 2 is a flow chart illustrating the process of scrolling digital content in a mobile terminal according to an embodiment of the present invention.

FIG. 3 is a drawing illustrating a method of scrolling digital content in a mobile terminal according to the first embodiment of the present invention.

FIG. 4 is a drawing illustrating a method of scrolling digital content in a mobile terminal according to the second embodiment of the present invention.

FIG. 5 is a drawing illustrating a method of scrolling digital content in a mobile terminal according to the third embodiment of the present invention.

FIG. 6 is a block diagram of the mobile terminal apparatus according to an embodiment of the present invention.

### SUMMARY OF THE INVENTION

An exemplary embodiment of the present invention provides a method for scrolling digital content in a mobile terminal embedded with a touch screen, the method comprising: receiving via the touch screen a user's dragging input drawing a circular trajectory; determining the scroll direction over the digital content based on whether the user's dragging input is clockwise or counter-clockwise and the scroll speed over the digital content based on the size of the circular trajectory; and scrolling over the digital content according to the determined scroll speed and the determined scroll direction.

It is preferable that the determining comprises: determining the scroll direction to be forward when the user's dragging input is clockwise and determining the scroll direction to be backward when the user's dragging input is counter-clockwise.

It is preferable that the method further comprising, displaying on the screen multiple circles representing reference lines for circular trajectories which are mapped onto scroll speeds that are different from one another.

It is preferable that the digital content is a video file or an audio file, and the scrolling comprises searching the user's desired point on the timeline of the video file or the audio file at a high speed or at a low speed.

It is preferable that the digital content is a list of multiple independent items, and the scrolling comprises browsing the multiple items.

Another exemplary embodiment of the present invention provides a computer readable recording medium having embodied thereon a computer program for executing the above method of performing scrolling.

Another exemplary embodiment of the present invention provides a mobile terminal apparatus comprising: a touch screen which detects a user's input; one or more memory in which a program for scrolling digital content according to the user's input received via the touch screen is stored; and one or more processor which execute the program stored in the one or more memory, wherein the one or more memory include instructions implementing the steps of: receiving via the touch screen a user's dragging input drawing a circular trajectory; determining the scroll direction over the digital content based on whether the user's dragging input is clockwise or counter-clockwise and the scroll speed over the digital content based on the size of the circular trajectory; and scrolling over the digital content according to the determined scroll speed and the determined scroll direction.

### DETAILED DESCRIPTION

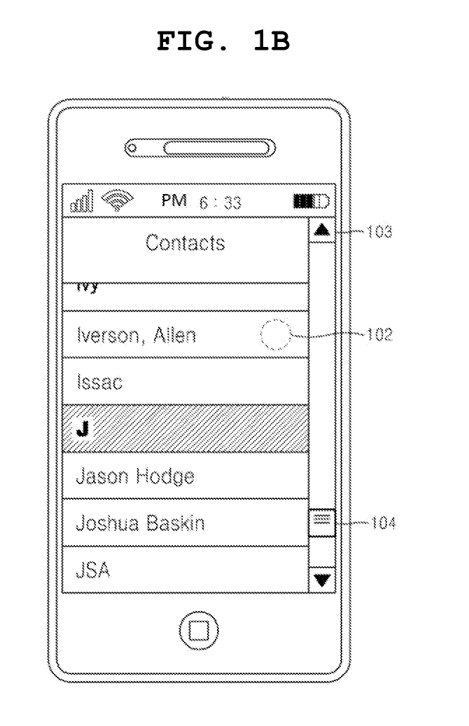

FIG. 2 is a flow chart illustrating the process of scrolling digital content in a mobile terminal according to an embodiment of the present invention. Hereinafter, digital content covers all kinds of digital data that can be displayed on a mobile terminal and scrolled according to a user's input. For instance, it may include an audio file, a video file, or a text file. Also, it may include multiple items such as contacts entries, file names, or the listing of icons.

In step 210, a user's dragging input drawing a circular trajectory is received via the touch screen of the mobile terminal. Appropriate error range may be set such that the mobile terminal may be operable to recognize the user's input as the circular trajectory according to the present invention even when the trajectory drawn by the user's touch point fails to be perfectly circular.

In step 220, the mobile terminal determines a scroll direction based on the dragging direction. For example, when the dragging direction is clockwise, the scroll direction may be forward and when the dragging direction is counter-clockwise, the scroll direction may be backward. In case of playing video or music, forward direction means ‘fast forward’ and backward direction means ‘rewind’.

In case of browsing a text document or a list of items, it is preferable that forward direction makes downward scroll and backward direction makes upward scroll.

In step 230, a scroll speed is determined based on the size of the circular trajectory. For example, in order to implement the user's intuitive scroll control, the larger the size is (to say, the smaller the curvature is), the faster the scroll speed may get, and the smaller the size is (to say, the larger the curvature is), the slower the scroll speed may get. Otherwise, it may be implemented the other way around.

The different scroll speeds represent that the scrolled intervals may be different for the same distance on the different circular trajectories drawn by the user's touch point.

For example, when the touch point draws two different-sized circular trajectories, one rotation of a larger circular trajectory may scroll twice the interval scrolled by one rotation of a smaller circular trajectory. In this case, the scroll speed of the larger circular trajectory is faster than that of the smaller one and the user may control the scroll more precisely using the smaller circular trajectory.

Alternatively, the interval scrolled by the touch point making one rotation along two different-sized circular trajectories may remain the same. In this case, the scroll speeds still may be said to be different to each other because the touch point moves different distances even though it moves with the same central angle for the two different circular trajectories. Specifically, the distance the touch point should travel along the arc in order to scrolling the same interval is longer for the larger circular trajectory, so smaller circular trajectory has faster scroll speed and the user may control the scroll more precisely using the larger circular trajectory.

The mechanism of determining the size of circular trajectory is not limited to a specific one. For example, it may be determined based on approximate curvature for the trajectory drawn by the user's touch point. Also, multiple circular reference lines with difference radiuses may be displayed in advance on the screen and determine which line the user's touch point moves along.

Step 220 and Step 230 may be performed in reverse order, or simultaneously.

In step 240, the mobile terminal performs scrolling through digital content according to the scroll direction and the scroll speed determined in step 230.

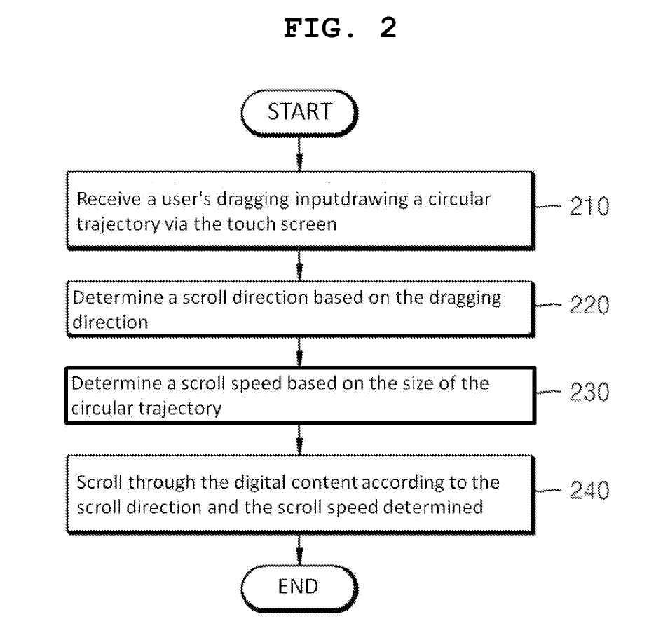

FIG. 3 is a drawing illustrating a method of scrolling digital content in a mobile terminal according to the first embodiment of the present invention.

In FIG. 3, the dotted lines represent the trajectories drawn by the dragging input via the user's touch point. As shown in FIG. 3, the user may drag the touch point along a circular trajectory of various sizes and the scroll speed is determined by the size of the circular trajectory. For example, a larger circular trajectory may have a faster scroll speed than a smaller one, so the scroll speeds of the circular trajectories may be arranged as \textcircled{1}, \textcircled{2}, \hat{3} in descending order. In this exemplary embodiment, the user need not drag the touch point within a specifically designated area. For example, the user may drag the touch point drawing the circular trajectory \textcircled{4}, and the scroll direction and the scroll speed still may be determined based on the dragging direction and the size of the circular trajectory, respectively.

As shown in FIG. 3, while the scroll is being performed, the mobile terminal may display the current scroll speed. For instance, the speed may be displayed in SPR (Seconds Per Rotation), which refers to the time interval covered by one rotation of the circular trajectory. Also, IPR (Items Per Rotation) 310, which refers to the number of items covered by one rotation of the circular trajectory, may be used.

As aforementioned, in some exemplary embodiment, the scroll speed may vary depending on the size of the circular trajectory even when SPR or IPR remains the same. For example, a larger circular trajectory has longer circumference than a smaller one, so the larger circular trajectory has the slower scroll speed than the smaller one because for the same central angle the touch point moving along the larger circular trajectory draws a longer arc than when it moves along the smaller circular trajectory. Therefore, the user may be able to perform a finer scroll using the larger circular trajectory.

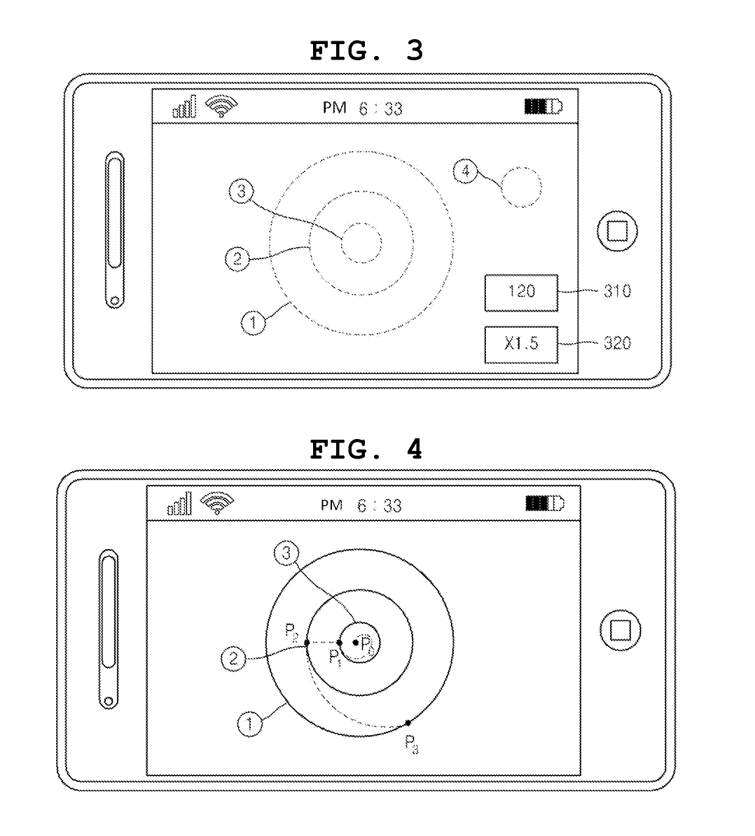

The scroll speed may be in the format representing the ratio which indicates a relative scroll speed. For example, assume the settings where the same interval is covered by one rotation of the circular trajectory \textcircled{1}, two rotations of the circular trajectory \textcircled{2}, or four rotations of the circular trajectory \textcircled{3}. In this example, while the touch point is moving along the circular trajectory \textcircled{1} the scroll speed may be displayed as X4 in comparison with the scroll speed of the smallest circular trajectory \textcircled{3}. Likewise, the scroll speed may be displayed as X2 while the touch point is moving along the circular trajectory \textcircled{2}. FIG. 4 is a drawing illustrating a method of scrolling digital content in a mobile terminal according to the second embodiment of the present invention.

As shown in FIG. 4, in this exemplary embodiment of the present invention the multiple circles are displayed on the screen in order to provide the user with the reference lines for circular trajectories. Therefore, when the user drags a touch point along one of the circular reference lines within a proper error range, the scroll is performed at a speed mapped onto the corresponding circular reference line. Each circular reference line is assigned to a different scroll speed. In this example, 3 reference lines (\textcircled{1}, \textcircled{2}, \textcircled{3}) are shown, but the number of the reference lines is not limited to particular one and it may vary according to the exemplary embodiments. The reference lines \textcircled{1}, \textcircled{2} and \textcircled{3} are mapped onto octuple speed, quadruple speed and double speed, respectively. In FIG. 4, the reference lines are depicted as concentric circles, but depending on the exemplary embodiments they may be arranged in different manners. The touch point moves along the dotted line, visiting the points P0, P1, P2 and P3 in sequence.

In this exemplary embodiment, the scroll speed remains the same when the touch point moves on the area between the reference lines. Specifically, when the touch point is placed on two reference lines, the scroll speed corresponding to the outer reference line applies.

Accordingly, while the touch point moves from P0 to P1 the scroll direction may be forward and the scroll speed may be normal speed. While the touch point moves from P1 to P2 it does not draw a circular trajectory along the reference lines, so there may be no scrolling at all. While the touch point moves from P2 to P3 the scroll direction may be backward and the scroll speed may be octuple speed.

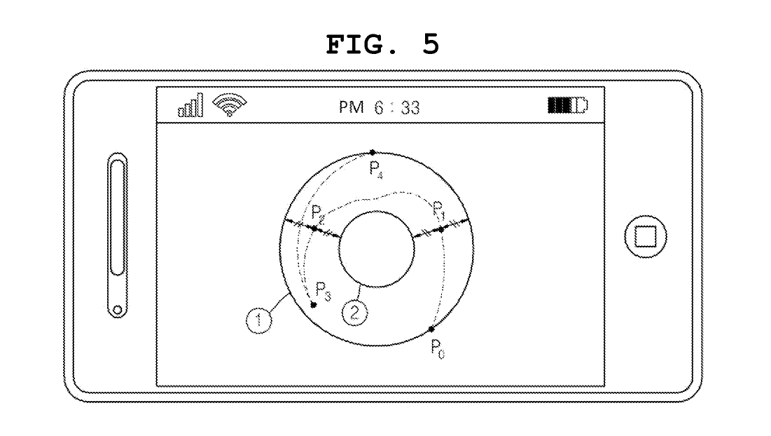

FIG. 5 is a drawing illustrating a method of scrolling digital content in a mobile terminal according to the third embodiment of the present invention.

In this exemplary embodiment, the circular reference lines are displayed on the screen as in the second embodiment, but only two reference lines are provided for convenience of explanation. Further, unlike the second embodiment, the scroll speed may change when the touch point moves the area between the reference lines based on the distance from the touch point to the reference lines. Specifically, the scroll speed corresponding to the reference line which is closer to the touch point than the other reference line applies. Here, the reference lines \textcircled{1} and \textcircled{2} are mapped onto octuple speed and quadruple speed, respectively.

The touch point meets P0, P1, P2, P3 and P4 in sequence as it moves along the dotted line. P1 and P2 is the point from which the distances to the reference lines \textcircled{1} and \textcircled{2} are identical.

While the touch point moves from P0 to P1, the scroll direction is backward and the scroll speed is octuple because the touch point maintains its location closer to the reference line \textcircled{1} than to the reference line \textcircled{2}. While the touch point moves from P1 to P2, the scroll direction is backward and the scroll speed is quadruple because the touch point maintains its location closer to the reference line \textcircled{2} than to the reference line \textcircled{1}. While the touch point moves from P2 to P3, the scroll direction is backward and the scroll speed is octuple because the touch point maintains its location closer to the reference line \textcircled{1} than to the reference line \textcircled{2}. While the touch point moves from P3 to P4, the scroll direction is forward and the scroll speed is still octuple because the touch point maintains its location closer to the reference line \textcircled{1} than to the reference line \textcircled{2}.

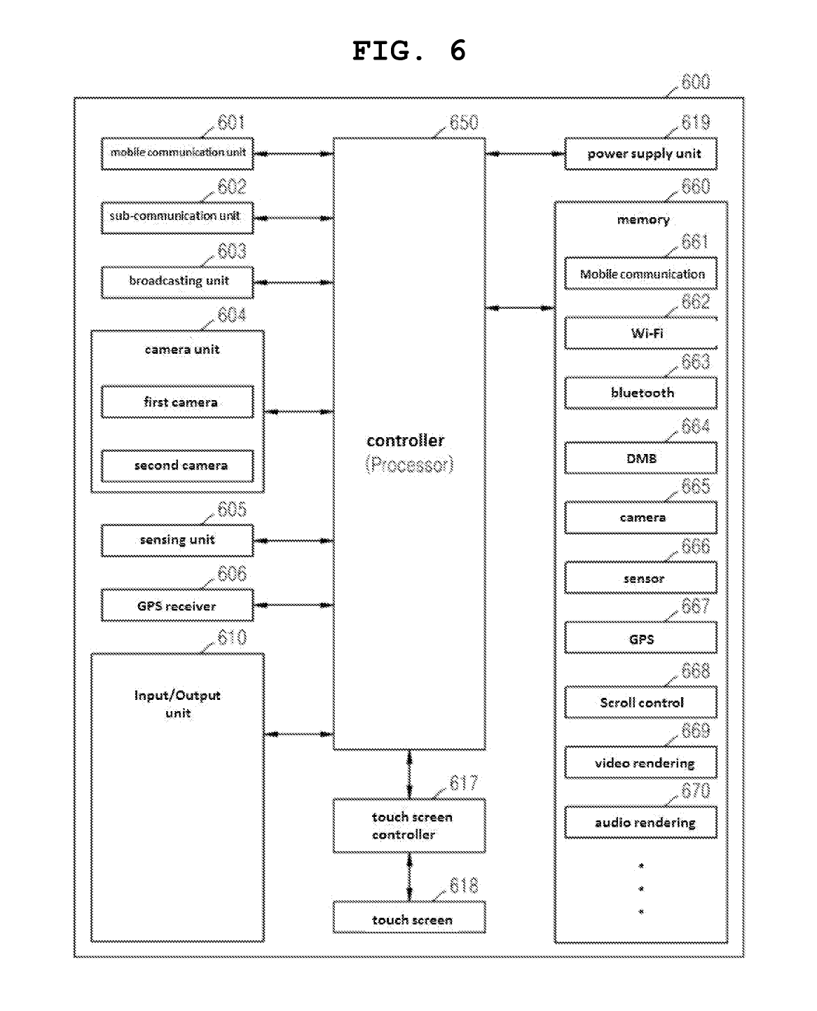

FIG. 6 is a block diagram of the mobile terminal apparatus according to an embodiment of the present invention.

A mobile communication unit 601 performs call-setup and data communication via a mobile communication network such as 3G/4G. A sub-communication unit 60 performs a process for local area communication such as Bluetooth, NFC, or the like. The broadcasting unit 603 receives a digital multimedia broadcasting (DMB) signal.

The camera unit 604 includes lenses and optical devices which capture an image or a moving image. Although in FIG. 6, the camera unit 604 includes two cameras, i.e., first and second cameras, the camera unit 604 may include a single camera or more than two cameras.

A sensing unit 605 may include any one or more of a gravity sensor which senses a motion of the mobile terminal 600, an illumination sensor which senses the brightness of light, an approach sensor which senses an extent of an approach of a person or object, and a motion sensor which senses a motion of a person.

A global positioning system (GPS) receiver 606 receives a GPS signal from an artificial satellite. By using the GPS signal, various services may be provided to a user.

An input/output unit 610 provides an interface between the mobile terminal and an external device or a person, and it may include a button, a microphone, a speaker, a vibration motor, a connector, a keypad, etc.

A touch screen 618 receives a touch input from a user. The touch input may include an input which is generated by various gestures such as dragging, flicking or tapping. A touch screen controller 617 delivers the touch input received via the touch screen 618 to the controller 650. A power supply unit 619 is connected with a battery or an external power source in order to supply a power for use by the mobile terminal 600.

The controller 650 controls units illustrated in FIG. 6 by executing programs stored in a memory 660, and performs various functions of the mobile terminal 600.

The programs stored in the memory 660 may be classified into a plurality of modules according to functions thereof. In particular, the programs may be classified into a mobile communication module 661, a Wi-Fi module 662, a Bluetooth module 663, a DMB module 664, a camera module 665, a sensor module 666, a GPS module 667, a scroll control module 668, a video rendering module 669 and an audio reproduction module 670.

Each module contains the instructions to execute its corresponding functions. Because a function of each of the modules may be inferred from the title thereof, only the scroll control module 668 will be described below.

When a user drags the touch point along a circular trajectory on the touch screen 1418 while a multimedia file is being played or multiple items are being browsed, the controller 650 determines the scroll direction and the scroll speed and accordingly perform the scroll over the multimedia content, by using the scroll control module 1468. For facilitating the user's intuitive scroll controlling, it is preferable that clockwise dragging causes forward scrolling and counter-clockwise dragging causes backward scrolling.

Here, the digital content may include a video file or an audio file, and performing the scroll may function as fast forward or rewind at a high speed or at a low speed. Alternatively, in case the digital content is a list of multiple items, performing the scroll may function as browsing the multiple items.

The above-described exemplary embodiments can be written as computer programs and can be implemented in general-use digital computers that execute the programs by using a transitory or non-transitory computer readable recording medium.

Examples of the computer readable recording medium include magnetic storage media (e.g., ROM, floppy disks, hard disks, etc.), optical recording media (e.g., CD-ROMs, or DVDs) and carrier wave (for example, transmission on the Internet).

While the present inventive concept has been particularly shown and described with reference to exemplary embodiments thereof, it will be understood by those of ordinary skill in the art that various changes in form and details may be made therein without departing from the spirit and scope of the exemplary embodiments as defined by the following claims. Accordingly, the disclosed exemplary embodiments should be considered in an illustrative sense rather than a limiting sense. The scope of the present inventive concept is defined not by the detailed description of the exemplary embodiments but by the appended claims, and all differences within the scope will be construed as being included in the present inventive concept.

1. A method for scrolling digital content in a mobile terminal embedded with a touch screen, the method comprising:
receiving via the touch screen a user's dragging input drawing a circular trajectory;
determining the scroll direction over the digital content based on whether the user's dragging input is clockwise or counter-clockwise and the scroll speed over the digital content based on the size of the circular trajectory; and
scrolling over the digital content according to the determined scroll speed and the determined scroll direction.

2. The method of claim 1, wherein the determining comprises:
determining the scroll direction to be forward when the user's dragging input is clockwise and determining the scroll direction to be backward when the user's dragging input is counter-clockwise.

3. The method of claim 1, further comprising,
displaying on the screen multiple circles representing reference lines for circular trajectories which are mapped onto scroll speeds that are different from one another.

4. The method of claim 1, wherein the digital content is a video file or an audio file, and the scrolling comprises searching the user's desired point on the timeline of the video file or the audio file at a high speed or at a low speed.

5. The method of claim 1, wherein the digital content is a list of multiple independent items, and the scrolling comprises browsing the multiple items.

6. A mobile terminal apparatus comprising:
a touch screen which detects a user's input;
one or more memory in which a program for scrolling digital content according to the user's input received via the touch screen is stored; and
one or more processor which execute the program stored in the one or more memory,
wherein the program include instructions implementing the steps of:
receiving via the touch screen a user's dragging input drawing a circular trajectory;
determining the scroll direction over the digital content based on whether the user's dragging input is clockwise or counter-clockwise and the scroll speed over the digital content based on the size of the circular trajectory; and
scrolling over the digital content according to the determined scroll speed and the determined scroll direction.

7. The apparatus of claim 6, wherein the determining comprises:
determining the scroll direction to be forward when the user's dragging input is clockwise and determining the scroll direction to be backward when the user's dragging input is counter-clockwise.

8. The apparatus of claim 6, the one or more program further include instructions implementing the step of displaying on the screen multiple circles representing reference lines for circular trajectories which are mapped onto scroll speeds that are different from one another.

9. The apparatus of claim 6, wherein the digital content is a video file or an audio file, and the scrolling comprises searching the user's desired point on the timeline of the video file or the audio file at a high speed or at a low speed.

10. The apparatus of claim 6, wherein the digital content is a list of multiple independent items, and the scrolling comprises browsing the multiple items.

11. A computer readable recording medium having embodied thereon a computer program for executing the methods of claim 1.
